(19) United States
(12) Patent Application Publication
(10) Pub. No.: US 2025/0223996 A1
(43) Pub. Date: Jul. 10, 2025

(54) GRAB HOOK WITH LOAD SUPPORT AREA FOR MULTI-DIRECTIONAL LOADS

(71) Applicant: Suncor Stainless, Inc., Plymouth, MA (US)

(72) Inventors: Patrick STRIEBEL, Duxbury, MA (US); David Dion, Marion, MA (US); James Storrer, Middleboro, MA (US)

(73) Assignee: Suncor Stainless, Inc., Plymouth, MA (US)

(21) Appl. No.: 19/092,589

(22) Filed: Mar. 27, 2025

Related U.S. Application Data
(63) Continuation-in-part of application No. 18/604,053, filed on Mar. 13, 2024, now Pat. No. 12,286,997.
(60) Provisional application No. 63/451,946, filed on Mar. 14, 2023.
(60) Provisional application No. 63/451,948, filed on Mar. 14, 2023.

(51) Int. Cl. F16B 45/02

(52) U.S. Cl. CPC F16B 45/023; F16B 45/024

(57) ABSTRACT

A fixable grab hook is disclosed, which includes an arced load support area for supporting a link of chain throughout a range of load angles without creating localized stresses which would cause the link of chain to fail prematurely. The fixable grab hook has a general C-shaped hook body defined by a top region, a bottom region, and bridging portion connecting the top region and bottom regions together at one end in a spaced relation to define a throat therebetween within which a link of chain is releasably engageable. The bridging portion includes a non-planar surface defining a multi-directional load support area.

### CROSS-REFERENCE TO RELATED APPLICATIONS

The present application is a continuation in part of U.S. patent application Ser. No. 18/604,053, filed Mar. 13, 2024, which claims the benefit of provisional application No. 63/451,946, filed Mar. 14, 2023, and provisional application No. 63/451,948, filed Mar. 14, 2023, the contents of all of which are incorporated herein by reference in their entirety.

### FIELD OF TECHNOLOGY

The present disclosure is in the field of grab and slip hooks, and more particularly, in the field of grab and slip hook assemblies for securing a linkage to a surface.

### BACKGROUND

Grab hooks are a type of lifting or rigging hardware used to securely attach and lift loads with chains or straps. They typically feature a hook with a narrow throat and a latch or latch mechanism that closes the opening, preventing the chain or strap from slipping out. Grab hooks are designed to grab onto the chain or strap securely, providing a reliable connection point for lifting and securing heavy loads. Grab hooks are commonly used in in industries such as construction, transportation, agriculture, and manufacturing for tasks involving lifting, towing, or securing objects.

Grab hooks with flat arcuate loading shapes cause the loaded link to rotate creating a point load on the link where high stresses can cause premature link failure below the rated breaking strength of the link.

Previously known hook designs have aimed to reduce or prevent point loads on a loaded link. Examples of the previously known hook designs include a saddle, wings, or cradle support to prevent the chain link from distorting or shearing prematurely. However, each of these previously known hook designs are configured for in-line loads wherein the hook is able to self-align with the load. In contrast a fixed grab hook is unable to self-align with the chain link and must facilitate loads pulling from a range of directions without damaging or compromising the integrity of the chain link.

### SUMMARY

Embodiments of the present disclosure include a fixable grab hook, having a general C-shaped hook body defined by a top region, a bottom region, and bridging portion connecting the top region and bottom regions together at one end in a spaced relation to define a throat therebetween within which a link of chain is releasably engageable. A non-planar surface extends around the bridging portion, from the top region to the bottom region, and provides therewith a multi-directional load support area for supporting the link of chain throughout a range of load angles without creating localized stresses which would cause said link of chain to fail prematurely.

In an illustrative embodiment, the non-planar surface comprises a bevel of at least 10 degrees on each side of the fixable grab hook. In one example, the bevel is between 10 degrees and 15 degrees on each side of said fixable grab hook.

In an illustrative embodiment, the multi-directional load support area has a width that is less than 2.5 times the diameter of the throat. In one example, the width of the load support area is about 2.3 times the diameter of the throat. In one example, the throat accommodates a linkage having a width between 0.25 inches and 0.75 inches.

According to an aspect of the present disclosure, the flexible grab hook further includes a pair of protruding contours extending transversely outwardly of the hook body around the bridging portions in opposite directions from the hook body, from the top region to the bottom region, and providing therewith an extra wide throat and a pair of multi-directional support shoulders for supporting the link of chain throughout a range of load angles from either side of the hook body without creating localized stresses which would cause the link of chain to fail prematurely. In an illustrative embodiment, the fixed grab hook includes a bevel around the throat to the protruding contour with a bevel angle of no less than 45 degrees.

In an illustrative embodiment, a protrusion height of each of the protruding contours is less that the diameter of the throat. According to an aspect of the present disclosure, the multi-directional support shoulders form an arc greater than 20 degrees from a centerline of the throat portion of hook on at least one side of the throat centerline. In one example, the multidirectional support shoulders form a top side of the arc having an arclength of about 45 degrees above the centerline and a bottom side of the arc having an arclength of about 35 degrees below the centerline.

In an illustrative embodiment, the bridging portion defines a curved end of the throat configured to support a loaded link. The curved end has a singular lateral surface about equal to or less than the diameter of a link.

In an illustrative embodiment of the present disclosure the fixable grab hook includes a flat bottom surface of the hook body for welding to a mounting surface or plate. In one example, the flexible grab hook includes a beveled edge between the flat bottom surface and a side surface of the body.

In another example the disclosed fixable grab hook includes a first pair of concave curved chamfers defining outward facing curved grooves extending along the top region, and a second pair of concave curved chamfers defining outward facing curved grooves extending along the bottom region.

### BRIEF DESCRIPTION OF THE DRAWINGS

FIG. 1 is a perspective view of an exemplary welded grab hook, according to an aspect of the present disclosure;

FIG. 2 is a perspective view of an exemplary bolted grab hook, according to an aspect of the present disclosure;

FIG. 3 is a perspective view of an exemplary welded slip hook, according to an aspect of the present disclosure;

FIG. 4 is a perspective view of an exemplary bolted slip hook, according to an aspect of the present disclosure;

FIG. 5 is a perspective view of an exemplary mount plate, according to an aspect of the present disclosure;

FIG. 6 is a perspective view of an exemplary backing plate, according to an aspect of the present disclosure;

FIG. 7 is a perspective view of the grab hook of FIGS. 1 and 2, illustrating the multi-direction support shoulder for choker loading and extra wide throat to support linkage loop loading, according to an aspect of the present disclosure;

FIGS. 8A and 8B are section views of an exemplary grab hook for chain support according to the PRIOR ART;

FIG. 9 is a section view of an exemplary grab hook for multi-directional chain support according to an aspect of the present disclosure;

FIG. 10 is a dimensional drawing of an exemplary grab hook for multi-directional chain support according to an aspect of the present disclosure; and

FIG. 11 is a side view drawing of an exemplary grab hook for multi-directional chain support according to an aspect of the present disclosure.

Like reference numerals in different Figures indicate like elements.

### DETAILED DESCRIPTION

Aspects of the present disclosure include various implementations of grab and slip hooks. Each of the hooks is provided in a weld-on configuration and a bolt on configuration. In implementations, the weld-on hook can be utilized for welding directly onto a structure. In implementations, the bolt-on hook can also include the weld-on hook, as it is welded to a mounting plate (for both grab & slip hooks) before fastening the hook with bolts to a structure. Backing plates may be available to both the grab and slip hooks. These grab hooks may accommodate linkages, such as chains, ropes, cords, and like components. In some implementations, these linkages may include thicknesses of ¼″, 5/16″, ⅜″ and ½″; however, other implementations may utilize alternate linkage dimensions. According to the present disclosure, these hook assembly systems can be arrayed, interchanged, and/or configured across a number of size categories of plates and hooks.

Traditional grab hooks may have a vee groove shape, with a 38°-45° angle to hold a linkage. However, disadvantageously, when using the loop method, this vee shape creates a point load can damage a chain link by bending the link. When using the choker method, the link in a traditional hook can fail in single shear before reaching chain-breaking strength. In some cases, the breaking strength is reduced by up to 28%. As a result, some manufacturers recommend a 20% reduction in the working load limit to compensate for premature damage.

Heretofore known hook designs to mitigate the above-mentioned point-load and shearing problems include saddle, wings, or cradle support to prevent the chain link from distorting or shearing prematurely. For example, U.S. Pat. No. 4,070,823 describes one of the earliest hook designs intended to prevent premature chain damage due to the above-mentioned point loads and shearing problems. Each of these previously known hook designs are configured to be used for in-line pull in a set direction that is self-aligning.

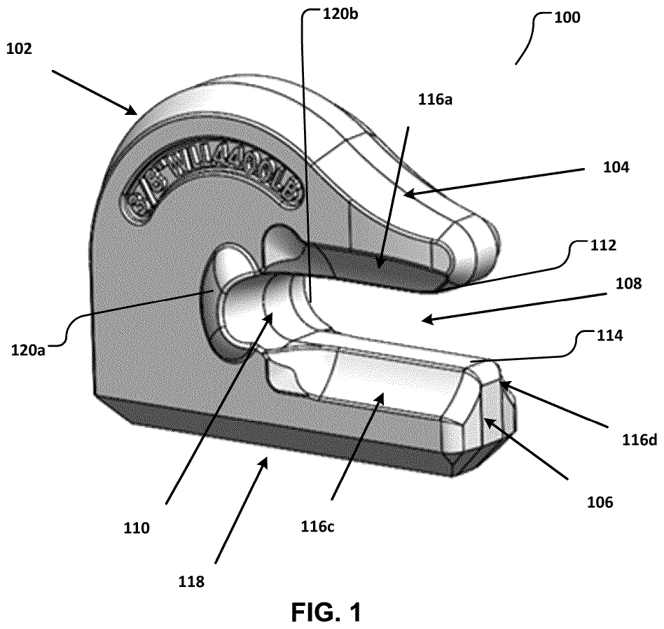

To address these issues, these hooks can also be designed with a multi-direction support shoulder. In implementations, this can assist with choker loading, and include an extra wide throat to support linkage loop loading. This can include both grab hooks, as illustrated in FIGS. 1, 2, and 7, and slip hooks (not shown).

FIG. 1 is a perspective view of an exemplary welded grab hook 100, according to an aspect of the present disclosure. Grab hook 100, which may also be referred to as fastener assembly 100, can include body 102, which can itself be defined by top region 104, bottom region 106, channel 108, and recess 110. As shown in FIG. 1, channel 108 may be defined within the body 102, and recess 110 may be defined within the channel 108. In implementations, channel 108 may include at least a first edge 112 and a second edge 114. Each of the first edge 112 and second edge 114 may include one or more sloped regions, such as regions 116a, 116b (opposite 116a, and not shown), 116c, and 116d. In implementations, first edge 112, second edge 114, and/or one or more sloped regions 116a-116d can assist with introducing a linkage, such as a chain, into the hook 100, and allow for it to readily manipulated within channel 108 and/or recess 110.

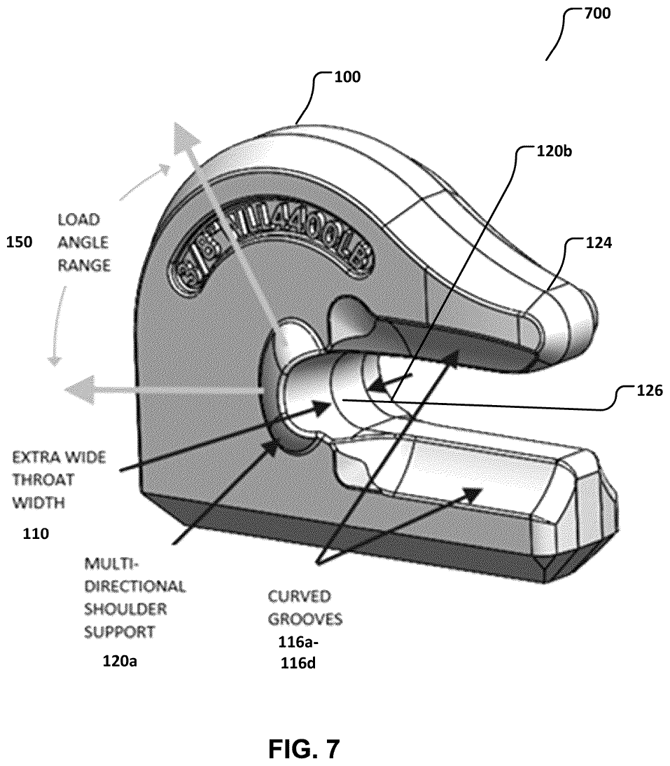

Also shown in FIG. 1, recess 110 may include one or more contours 120a and 120b. These contours 120a and 120b, which may be axially orientated about the recess 110, can serve as a multi-direction support shoulder when a linkage is introduced into channel 108 of hook 100, as previously introduced. This can help prevent the linkage from distorting and/or shearing prematurely, and will be discussed at greater length in FIG. 7.

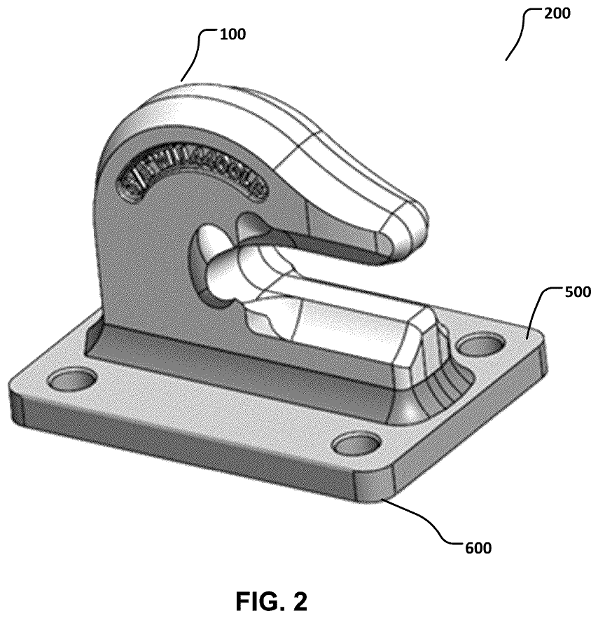

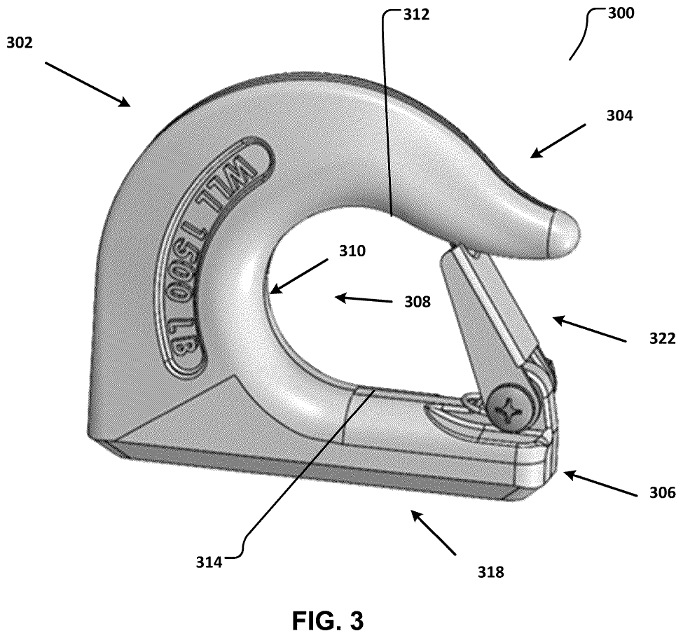

Bottom region 106 of FIG. 1 also includes beveled region 118. This region 118, as shown in FIGS. 1 and 2, can be concave for more ready fastening to surfaces. In implementations, beveled region 118 can be coupled to a surface, such as mount plate 500. This coupling can include welding without a surface and/or subsurface, as shown in FIGS. 1 and 3, or bolting/welding to a surface and/or subsurface, or other like methods. Grab hook 100 can also include a clevis and/or an eye, in some implementations.

FIG. 3 is a perspective view of an exemplary welded slip hook 300, according to an aspect of the present disclosure. Slip hook 300, which can also be referred to as fastener assembly 300, is similar to grab hook 100. Slip hook 300 can include body 302, which can itself be defined by top region 304, bottom region 306, channel 308, and recess 310. As shown in FIG. 3, channel 308 may be defined within the body 302, and recess 310 may be defined within the channel 308. Channel 308 may include at least a first edge 312 and a second edge 314. In implementations, first edge 312 and/or second edge 314 can assist with introducing a linkage, such as a chain, into the hook 300, and allow for it to readily manipulated within channel 308 and/or recess 310.

FIG. 3 may further include latch 322, which may be configured on second edge 314 of bottom region 306 to open and close along the interior of first edge 312 of top region 304. Latch 322 may include a spring-and bolt type mechanism, and may be activated when latch 322 receives a pressing force upon its face. In implementations, once latch 322 receives this pressing force, it can spring closed behind the object introducing the force, and can thereby secure channel 308 and prevent the exit of these objects, which can include linkages such as ropes, chains, and like components.

While not shown in FIG. 3, recess 310 can include one or more contours. These contours, which may be axially orientated about the recess 310, can serve as a multi-direction support shoulder when a linkage is introduced into channel 308 of hook 300, as previously introduced. This can help prevent the linkage from distorting and/or shearing prematurely, and will be discussed at greater length in FIG. 7.

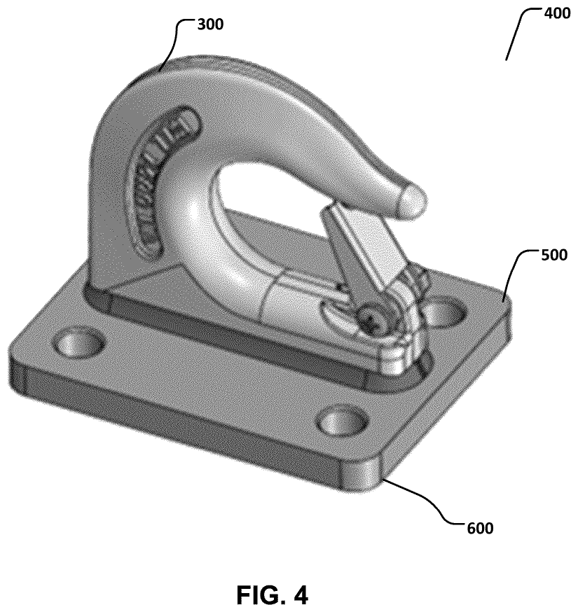

Bottom region 306 of FIG. 3 also includes beveled region 318. This region 318, as shown in FIGS. 3 and 4, can be concave for more ready fastening to surfaces. In implementations, beveled region 318 can be coupled to a surface, such as mount plate 500. This coupling can include welding without a surface and/or subsurface, as shown in FIGS. 1 and 3, or bolting/welding to a surface and/or subsurface, as shown in FIGS. 2 and 4, or other like methods.

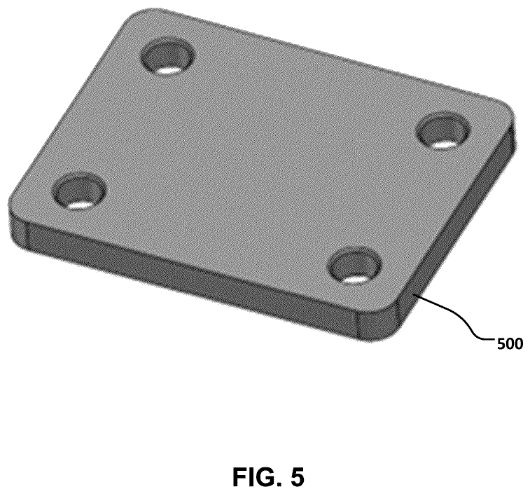

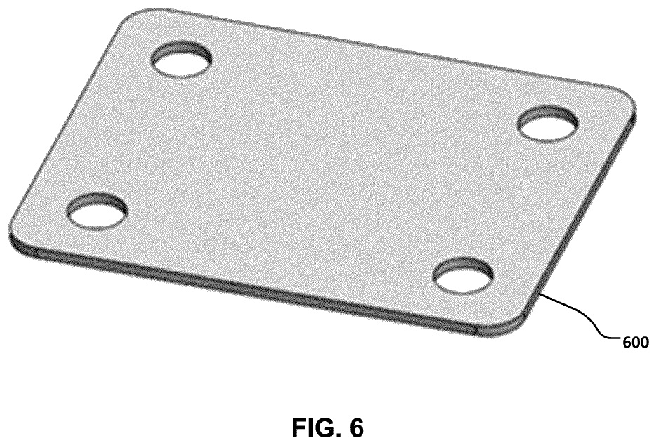

FIG. 5 is a perspective view of an exemplary mount plate 500, and FIG. 6 is a perspective view of an exemplary backing plate, according to aspects of the present disclosure. Mount plate 500 can be further coupled to a subsurface, such as backing plate 600. Backing plate 600 may be the same dimensions as mount plate 500, but thinner, so as to be disposed beneath. In implementations, mount plate 500 can be coupled to backing plate 600 via fasteners, welding, adhesive, bolts, or like methods. Backing plate 600 can be thereby mounted on the underside of mount plate 500 as relating to hooks 100 and/or 300 via bolting, for re-enforcement strength to the overall assembly. In implementations, and as shown in views 200 and 400 in FIGS. 2 and 4, respectively, beveled regions 118 and 318 of hooks 100 and 300, respectively, can be welded onto a moving device, which can include a surface such as mount plate 500. These hooks 100 and/or 300 may be used for chain pulling applications, fibrous webbing, rope loops, and/or shackle attachments, with each hook 100 and/or 300 capable of being sized with specific groove design for the corresponding linkage size.

FIG. 7 is a perspective view 700 of the grab hook 100 of FIGS. 1 and 2, illustrating the advantages offered by recess 110, one or more contours 120a and 120b, and/or sloped regions 116a-116d. While grab hook 100 is illustrated, slip hook 300 can also possess like advantages and/or features, in some implementations. Top region 104 and/or bottom region 106, which may also be referred to as one or more curved surfaces, include an opening, which can be channel 108, and can include top edge 124 of body 102, which may be adjacent to the opening 108.

In FIG. 7, recess 110 includes an extra wide throat width, as previously introduced, referred to as one or more contours 120a and 120b, which can also be referred to as shoulder supports 120a and 120b. In some implementations, channel 108 accommodates a linkage with a width between 0.25 inches and 0.5 inches. In some implementations, the linkage has a width between 0.25 and 0.75 inches. In this way, one or more contours 120a and 120b can reduce and/or dissipate stress points from linkages during use. In some implementations, sloped regions 116a-116d, also referred to as curved grooves 116a-116d, can further assist with reducing and/or dissipating stress points from linkages during use, as the linkage moves freely within opening/channel 108 without applying too much stress along first edge 112 and/or second edge 114. In addition, one or more contours 120a and 120b can prevent the linkage from distorting the hook 100 in the choker method.

In an implementation of the present disclosure, grab hook 100 fitting is fixed, and the linkage can pull in a range of angles, as shown in load angle range 150 of FIG. 7. Recess 110, which can also include inner surface 126, can itself include a non-zero angle as a result of the width of one or more contours 120a and 120b. In some implementations, recess 110 further includes inner surface 126 with an angle no less than 45 degrees when retaining a linkage within channel 108. In some implementations, one or more sloped regions 116a-116d include an angle of no less than the angle of the inner surface 126 of the recess 110. In some implementations, inner surface 126 can utilize a non-zero angle to apply a retaining force, as the retaining force mitigates damage to linkages received within the channel 108.

In practice, a user can fasten an assembly, such as hooks 100 and/or 300, to a linkage by introducing the linkage to channel 108 of the fastener assembly 100 and/or 300 by positioning the linkage towards recess 110 of channel 108 within body 102 of the fastener assembly 100 and/or 300. By way of at least one sloped region 116a-116d, which can be an edge 112 and/or 114 of channel 108, hook 100 and/or 300 can retain the linkage within the channel 108 within the recess 110 at an angle of no less than 45 degrees to successfully perform a fastening operation, as disclosed herein.

In an illustrative embodiment such as the embodiment shown in FIG. 7, the present application includes a fixable grab hook, having a general C-shaped hook body defined by a top region, a bottom region, and bridging portion connecting the top region and bottom regions together at one end in a spaced relation to define a throat therebetween within which a link of chain is releasably engageable. The fixable grab hook includes a protruding contour extending transversely outwardly of the hook body around the bridging portion, from the top region to the bottom region, and provides therewith a multi-directional support shoulder for supporting the link of chain throughout a range of load angles without creating localized stresses which would cause the link of chain to fail prematurely.

As shown in FIG. 7, the fixable grab hook may include a pair of protruding contours extending transversely outwardly of the hook body around the bridging portions in opposite directions from the hook body, from the top region to the bottom region, to provides therewith an extra wide throat and a pair of multi-directional support shoulders for supporting the link of chain throughout a range of load angles from either side of the hook body without creating localized stresses which would cause the link of chain to fail prematurely.

The fixable grab hook shown in FIG. 7 also includes a bevel around the throat to the protruding contour, in which the bevel has a bevel angle of no less than 45 degrees. In addition, a first pair of bevels may extend along the top region and a second pair of bevels extends along the bottom region. In an illustrative embodiment, at least one of the first pair of chamfers and second pair of chamfers has a bevel angle no less than the bevel angle around the throat to the protruding contour.

In the fixable grab hook shown in FIG. 7 a first pair of concave curved chamfers and a second pair of concave curved chamfers are shown in place of the first and second pair of bevels, respectively. The first pair of curved chamfers define outward facing curved grooves extending along the top region the second pair of concave curved chamfers defining outward facing curved grooves extending along the bottom region.

In an illustrative embodiment, the fixable grab hook may have a non-zero angle between an inner surface of the top portion and an inner surface of the bottom portion.

As shown in FIG. 7, the fixable grab hook includes a flat bottom surface of the hook body for welding to a mounting surface or plate and a beveled edge between the flat bottom surface and a side surface of the body.

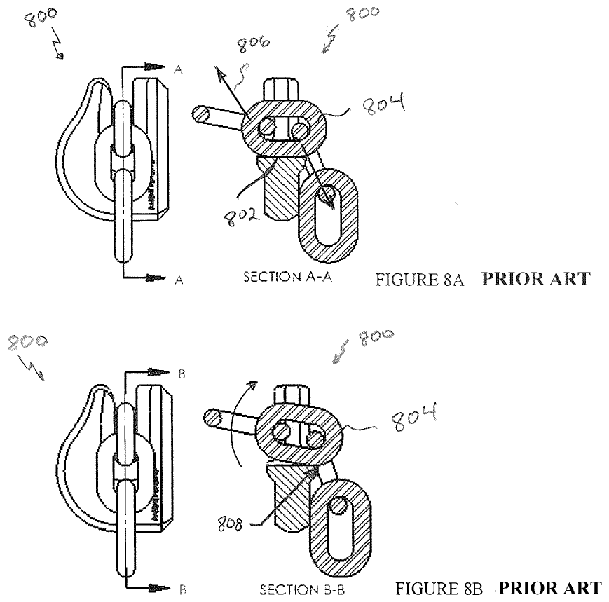

Referring to FIGS. 8A and 8B, an example of a previously known chain support surface of a hook 800 includes a flat support surface or shelf 802 supporting a chain link 804 which when subject to a load 806 that tends to rotate the chain link 804. The rotated chain link is subject to a point load at a corner 808 of the shelf 802, which may overstress, bend, distort or break or otherwise weaken the chain link 804.

In contrast, embodiments of the disclosed grab hook incorporates a multi-direction support shoulder for chocker loading. Embodiments of the disclosed grab hook also include an extra wide throat portion 110, (see FIG. 7) to support loop loading, both to avoid chain link damage and to achieve full chain breaking strength.

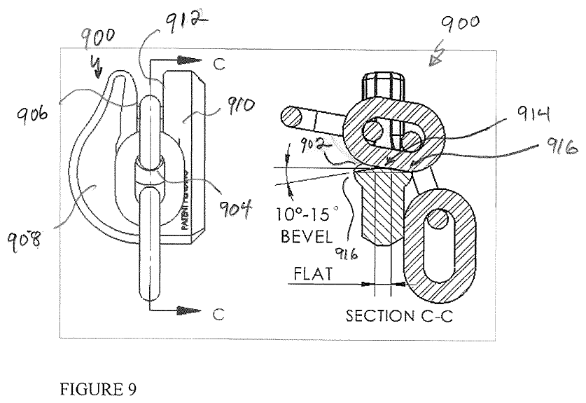

Referring to FIG. 9, according to an aspect of the present disclosure, the disclosed grab hook 900 includes distinct non-coplanar beveled shelf portions 902. The shelf portions 902 have a non-planar surface extending around the bridging portion 904, from the top region 908 to the bottom region 910, and providing therewith a multi-directional load support area. The shelf portion 902 may also extend along the top inside surface 906 and/or bottom inside surface 912 of the grab hook 900. In an illustrative embodiment, the non-planer surface includes a flat middle portion 914 and a bevel 916 on either side of the flat middle portion 914 such that the flat middle portion 914 does not extend the full width of the grab hook 900. In an illustrative embodiment the bevel 916 is about 10 degrees to about 15 degrees on either or both sides of the flat middle portion 914. In another embodiment, as shown in FIG. 7, the bevel may be replaced by curved grooves 116a-116d. The bevel or curved grooves prevent the link from distorting the hook in the choker method as well as supporting the chain link.

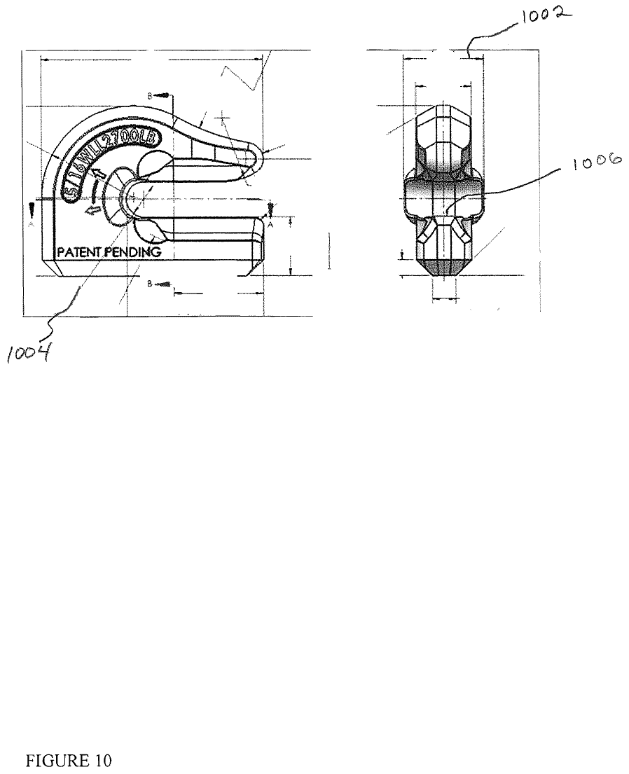

Referring to FIG. 10, in an illustrative embodiment the shelf overall width 1002 is about 2.3 times wider than the throat opening 1004. In one example, the shelf overall width 1002 is 0.90 inches and the throat opening 1004 is 0.39 inches. In in illustrative embodiment, the flat middle portion 1006 is approximately as wide as a chain link diameter of a chain to be retained by the grab hook.

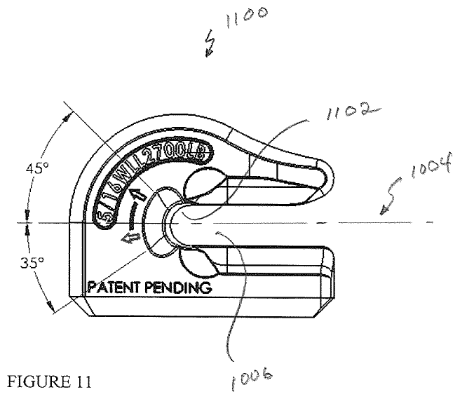

Referring to FIG. 11, according to an aspect of the present disclosure, multi-directional support shoulders of the disclosed grab hook 1100 form an arc 1102 greater than 20 degrees from a centerline 1004 of the throat portion 1006 of the hook on at least one side of the throat centerline 1004. In an illustrative embodiment, the multidirectional support shoulders form a top side of the arc having an arclength of about 45 degrees above the throat centerline and a bottom side of the arc having an arclength of about 35 degrees below the centerline.

The fittings disclosed herein are fabricated from stainless steel. In some implementations, the disclosed mounting plates are either 316 L or 304 L low carbon grade for welding. The backing plate is either 316 or 304 stainless steel. Although the disclosed implementations, are made from stainless steel, it should be understood that various alternative implementations may be made from other metals, such as brass, bronze, aluminum and the like, and other materials including plastic, fiberglass, carbon fiber, or the like.

Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

Other implementations not specifically described in this specification are also within the scope of the following claims.

What is claimed is:

1. A fixable grab hook, having a general C-shaped hook body defined by a top region, a bottom region, and bridging portion connecting the top region and bottom regions together at one end in a spaced relation to define a throat therebetween within which a link of chain is releasably engageable, the fixable grab hook comprising:
a non-planar surface extending around said bridging portion, from said top region to said bottom region, and providing therewith a multi-directional load support area for supporting said link of chain throughout a range of load angles without creating localized stresses which would cause said link of chain to fail prematurely.

2. The fixable grab hook of claim 1, wherein said non-planar surface comprises a bevel of at least 10 degrees on each side of said fixable grab hook.

3. The fixable grab hook of claim 2 wherein said bevel is between 10 degrees and 15 degrees on each side of said fixable grab hook.

4. The fixable grab hook of claim 1, wherein the multi-directional load support area has a width that is less than 2.5 times the diameter of said throat.

5. The fixable grab hook of claim 4, wherein said width is about 2.3 times the diameter of said throat.

6. The fixable grab hook of claim 1, comprising a pair of protruding contours extending transversely outwardly of said hook body around said bridging portions in opposite directions from said hook body, from said top region to said bottom region, and providing therewith an extra wide throat and a pair of multi-directional support shoulders for supporting said link of chain throughout a range of load angles from either side of said hook body without creating localized stresses which would cause said link of chain to fail prematurely.

7. The fixable grab hook of claim 6 wherein an overall width of said multi-directional support shoulders is less than 2.5 times the diameter of said throat.

8. The fixable grab hook of claim 7 wherein the overall width of said multi-directional support shoulder is about 2.3 times the diameter of said throat.

9. The fixable grab hook of claim 6, wherein a protrusion height of each of said protruding contours is less that said diameter of said throat.

10. The fixable grab hook of claim 6, wherein said multi-directional support shoulders form an arc greater than 20 degrees from a centerline of said throat portion of hook on at least one side of the throat centerline.

11. The fixable grab hook of claim 10, wherein said multidirectional support shoulders form a top side of said arc having an arclength of about 45 degrees above said centerline and a bottom side of said arc having an arclength of about 35 degrees below said centerline.

12. The fixable grab hook of claim 1, wherein said bridging portion defines a curved end of said throat configured to support a loaded link, wherein said curved end includes a singular lateral surface about equal to or less than the diameter of a link.

13. The fixable grab hook of claim 1, wherein the throat accommodates a linkage, wherein the linkage having a width between 0.25 inches and 0.75 inches.

14. The fixable grab hook of claim 1, comprising a flat bottom surface of the hook body for welding to a mounting surface or plate.

15. The fixable grab hook of claim 14, comprising a beveled edge between the flat bottom surface and a side surface of the body.

16. The fixable grab hook of claim 1, comprising:
a first pair of concave curved chamfers defining outward facing curved grooves extending along said top region; and
a second pair of concave curved chamfers defining outward facing curved grooves extending along said bottom region.

17. The fixable grab hook of claim 6, comprising: a bevel around said throat to said protruding contour, the bevel having a bevel angle of no less than 45 degrees.

18. The fixable grab hook of claim 1, wherein the load support area is arced.
